(19) United States
(12) Patent Application Publication
(10) Pub. No.: US 2004/0131935 A1
(43) Pub. Date: Jul. 8, 2004

(54) [Cell]

(76) Inventors: Noriyoshi Munenaga, Minami-ku (JP); Isao Suzuki, Minami-ku (JP); Minoru Hirata, Minami-ku (JP); Seiji Nemoto, Minami-ku (JP); Takehito Matsubara, Minami-ku (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,109

(22) Filed: Nov. 21, 2003

(30) Foreign Application Priority Data
Nov. 25, 2002 (JP) 2002-341260

(51) Int. Cl. H01M 2/26; H01M 6/10; H01M 2/02; H01M 10/40

(52) U.S. Cl. 429/211; 429/94; 429/161; 429/178; 429/176; 29/623.1

(57) ABSTRACT

A cell comprising: a lead; a power generating element which comprises a positive electrode, a negative electrode, and a separator; and a core, wherein said lead for taking current from said power generating element is fixed on said core, and said lead is connected to said positive electrode or said negative electrode.

### CROSS REFERENCE TO RELATED APPLICATIONS

This application claims the priority benefit of Japanese application serial no.2002-341260, filed on Nov. 25, 2002.

### BACKGROUND OF INVENTION

1. Field of the Invention

The present invention relates to a cell having a power generating element.

2. Description of the Related Art

In some non-aqueous electrolyte secondary cells, for the sake of a thinner and lighter configuration, a wound type power generating element of an elliptic cylindrical shape is housed in an aluminum resin laminate sheet of a bag-like shape. FIG. 6 shows the configuration of a prior art example of a power generating element in such a non-aqueous electrolyte secondary cell. The power generating element 1 is formed by winding a positive electrode 12 and a negative electrode 13 around a core 11 such as shown in FIG. 6(a) with a separator 14 therebetween, as shown in FIG. 6(b). The core 11, as shown in FIG. 6(a), is formed by rolling a short strip of an insulating resin sheet, such as PET (polyethylene terephthalate) or PP (polypropylene), more than one round, the end of which is then fastened with an adhesive tape 15. For the core 11, a resin molding which is formed into, for example, an elliptic cylindrical shape can also be used.

In the positive electrode 12 of the power generating element 1 as described above, the positive active material is coated on the surface of a strip aluminum foil, which is wider than the core 11, and in the negative electrode 13 thereof, the negative active material is coated on the surface of a strip copper foil, which has almost the same width as the positive electrode 12. In this case, however, the positive active material is not coated on the one edge portion of the strip (the upper portion in FIG. 6), so that the aluminum foil has the non coated part of the positive electrode 12. In the same manner, the negative active material is not coated on the other edge portion of the strip (the lower portion in FIG. 6), so that the copper foil has the non coated part of the negative electrode 13. The separator 14 comprises a strip micro porous membrane made of PE (polyethylene), which is slightly narrower than the positive electrode 12 and the negative electrode 13. The positive electrode 12 and the negative electrode 13 as described above are wound, centering on the core 11, with the separator 14 therebetween. The positive electrode 12 and the negative electrode 13 are, in this case, wound with being slightly shifted in the vertical direction from each other, so that, as shown in FIG. 6(b), only one edge portion of the aluminum foil of the positive electrode 12 protrudes from the one end of the power generating element 1 (the upper end in FIG. 6) and only the other edge portion of the copper foil of the negative electrode 13 protrudes from the other end (the lower end in FIG. 6.). The separator 14 is wound on the center part of the power generating element 1, except for the protruding upper and lower edge portions, so as to surely cover the portion where the positive electrode 12 and the negative electrode 13 overlap with each other. The separator 14 is wound more than one round after the completion of the winding process of the positive electrode 12 and the negative electrode 13, and the end of the strip is fastened with an adhesive tape in order for the winding not to come loose.

In the configuration of the power generating element 1 as described above, a positive lead 2 is inserted into one edge portion of the core 11 (the upper end in FIG. 6) and a negative lead 3 is inserted into the other edge portion thereof (the lower end in FIG. 6), as shown in FIG. 6(c). The positive lead 2 comprises an aluminum plate and the negative lead 3 comprises a copper plate. The aluminum foil portion of the positive electrode 12, which protrudes from one end of the power generating element 1, is lapped and then connected to the positive lead 2 by ultra sonic wave welding, and the copper foil portion of the negative electrode 13, which protrudes from the other end of the power generating element 1, is lapped and then connected to the negative lead 3 by ultra sonic wave welding. The power generating element 1 is housed in an aluminum resin laminate sheet of a bag-like shape, an electrolyte is then poured into the bag, and the bag is hermetically sealed with parts of the positive lead 2 and the negative lead 3 protruding respectively, thereby producing a non-aqueous electrolyte secondary cell.

However, since the positive lead 2 and the negative lead 3 are respectively connected only to the aluminum foil and the copper foil portions, which are non coated parts of the positive electrode 12 and the negative electrode 13, when any shock or vibration is given to the non-aqueous electrolyte secondary cell, the power generating element 1 being disposed inside could move, thereby causing a problem in that the aluminum foil or the copper foil portion is broken at the part of connection to the positive lead 2 or the negative lead 3. And in the conventional non-aqueous electrolyte secondary cell as described above, while the positive lead 2 and the negative lead 3 are inserted into the core 11 of the power generating element 1 and then connected to the respective electrodes by ultra sonic wave welding, there arise a possibility that the positive lead 2 or the negative lead 3 could be shifted from the right position. This may cause a problem in that the connection cannot be made in the right position or the sufficient electrical connection cannot be provided for the connection.

The present invention has been conducted in view of such problems. It is an object of the invention to provide a cell in which leads are fixed in advance on a core of a power generating element, so that the connection between a lead and an electrode is secured and the electrode in the connection part is prevented from breaking.

### SUMMARY OF INVENTION

The present invention provides a cell comprising: a lead; a power generating element which comprises a positive electrode, a negative electrode, and a separator; and a core, wherein said lead for taking current from said power generating element is fixed on said core, and said lead is connected to said positive electrode or said negative electrode.

According to the present invention, a lead is not only connected to an electrode of a power generating element but also fixed on a core; therefore, even when a shock or vibration is given to the cell, with the lead being supported by the core, the power generating element can be prevented from moving independently inside the cell. In case of a great impact or vibration, the lead moves together with the power generating element, so that too much force can be prevented from being applied to the position where the lead is connected to the electrode, and hence the breaking of the electrode can be avoided in the connected position. In addition, even when certain external force is applied to the end of the lead protruding from the cell, with the lead being fixed on the core, the force is not transmitted to the connection part of the lead end and the electrode inside the cell, and consequently the electrode in the connection part is not broken. Furthermore, fixed in advance on the core, the lead can be stable so as to be readily connected in the right position during the connection process of the lead and the electrode, and sufficient electrical connection can be provided through the connection of the lead and the electrode.

Considering the configuration of such a cell, there are two configuration types: a cell comprising a power generating element of wound type, in which electrodes are wound around a core; and a cell comprising a power generating element of stacked type, in which electrodes are stacked together with a core.

In the former configuration type, a cell has a wound type power generating element in which electrodes are wound around a core, wherein the lead is fixed on the core and connected to the electrode. Therefore, for example, a power generating element can be formed by winding one positive electrode and one negative electrode around a core with one separator therebetween. This has the advantage of being able to reduce the number of members required for the configuration of a power generating element. In this configuration, in addition, wherein a cell has a wound type power generating element in which a positive electrode and a negative electrode are wound around a core, which is formed by rolling a resin sheet more than one round, or a plate core with a separator therebetween, a positive lead being connected to a positive terminal is not only connected to the positive electrode protruding from one end of the power generating element but also fixed on one end of the resin sheet of the core, and a negative lead being connected to a negative terminal is not only connected to the negative electrode protruding from the other end of the power generating element but also fixed on the other end of the resin sheet of the core. In this case, the power generating element can be supported more securely with the positive lead and negative lead being connected to both ends of the core, and the positive lead and the negative lead can be previously fixed on both ends of the core made of resin sheet; therefore, it is possible to surely prevent problems that the connection cannot be made in the right position or to a satisfactory extent, from occurring.

In the latter configuration type, on the other hand, a cell has a stacked type power generating element in which electrodes are stacked together with a core, wherein said lead is fixed on the core and connected to the electrode. For example, it is possible to form a power generating element in such a manner as shown in FIG. 4. Therefore, a power generating element can be formed by stacking, for example, more than one positive electrodes and more than one negative electrodes together with more than one cores with more than one separators therebetween. This has the advantage of being able to form a power generating element through a simple process of stacking only.

Concerning the material of a lead, any conductor which can pass electricity well, will do; for example, aluminum, nickel, copper or iron is preferable. The shape of the lead may be determined depending on the shape of a cell, the internal structure of the cell, the way to fix the lead on the core, or the way to connect the lead to the electrode. Among the ways to connect an electrode to a lead, soldering, ultra sonic wave welding, welding, and rivet fixation are included. The term “a lead is connected to an electrode,” means that the lead and the electrode make contact each other to establish the condition where electricity can pass. As for the way to fix a lead on a core, the lead can be fixed on the surface of the resin molding, or a part of the lead can be implanted to the resin molding and then fixed by an insert molding, if the core comprises a resin molding. Furthermore, the lead can be fixed with an adhesive tape or by an implant molding.

A lead connected to an electrode can be disposed so as to protrude directly outside a cell. This allows the number of members to be reduced and the electricity generated by a power generating element to be taken outside the cell. In addition, a lead can be so disposed as not to protrude directly outside a cell. In this case, the lead is housed completely inside the cell. Connecting this lead to a terminal which can conduct electricity to the outer surface of the cell makes it possible for the electricity generated by the power generating element to be taken to the outside of the cell through the lead. As for the material of the terminal used in this case, any conductor which can pass electricity well will do; for example, aluminum, nickel, copper or iron is preferable. The shape of the terminal may be determined depending on the shape of the cell, the internal structure of the cell, the way to fix the lead on a core, or the way to connect the lead to an electrode.

As for the core, it is possible to use a core which has the shape of resin molding as it is, which is formed by rolling a molded resin sheet, which is cut into the shape of a plate, or which is formed by stacking. In any case, it is preferable to hold rigidity to the extent of being able to serve as a core.

Concerning the material of the core, such insulating materials are preferable as polypropylene, polyethylene, polyethylene terephthalate, or polyphenylene sulfide and so on. By using an insulating material, even when both of the leads which are respectively connected to the positive electrode and the negative electrode are fixed on one core, a short circuit is prevented from occurring. Therefore, in both electrode sides, the effect of the present invention can be obtained.

In case that an insulating material is not used for a core, having insulation coating around the core, especially over the area where a lead is to be fixed, can produce the same effect as using an insulating material for the core. For example, the area of the core surface can be covered with an insulating tape.

The size of a core can be flexibly adjusted depending on the size of a cell. In case of a power generating element of wound type having a core, it is preferable that the core have an appropriate size to be able to be housed into the center part of winding. In case of a power generating element of stacked type having a core, it is preferable that the core be almost the same size as an electrode. In either case, non coated parts of electrodes should be placed so as to lie outside the end of the core. In other words, it is recommended that the connection part of the lead and the electrode lie outside the end of the core. This prevents the core, as shown in FIG. 4 for example, from standing in the way when the non coated part of the positive electrode and the positive lead are connected at the right end of the lead in FIG. 4, and in addition allows the non coated part of the electrodes and the lead to be connected firmly. Regarding the thickness of the core, it is preferable to have a thickness with rigidity enough to be able to serve as a core. In case of a power generating element of stacked type, either one or a plurality of cores can be used. When a plurality cores are used, the positive and negative leads can be fixed on separate cores. Either positive or negative lead alone may be fixed on a core, or both positive and negative leads may be fixed on a core.

For a cell case housing a power generating element, a laminate film sheet can be used: an overview of the cell is shown in FIG. 5. This allows the total cell weight to be lighter than using a metal can as a case. The shape of the laminate film sheet 22 can be flexibly adjusted so as to fit the shape of the power generating element, and hence the cell case can be produced easily. As shown in FIG. 5, when the laminate film sheet 22 is used for the case, it is possible to have the effect of the present invention more pronouncedly. In other words, when the positive lead 2 or the negative lead 3 is not connected to the core, in the event that, for example, certain external force is applied to the top end of the positive lead 2 of the front side in the FIG. 5 in a downward direction, the positive lead 2, with the area where the positive lead 2 is sealed with the laminate film case 22 serving as a point of support, experiences the force in an upward direction in the FIG. 5 at the other lead end lying in the part of connection to the non coated part of the electrode disposed inside the cell 24, and hence it is possible that the positive lead 2 is detached from the non coated part of the electrode or that the non coated part of the electrode is broken. In addition to this, there is fear that the end of the positive lead 2 lying inside the cell can damage the inner face of the laminate film case 22. When the damage in the laminate film case 22 becomes serious, there is further fear that moisture in the atmosphere infiltrates inside the cell 24, or that the electrolyte which is poured inside leaks out of the cell 24. Such fear does not arise when a metal can is used as a case; however, the present invention can provide solutions to such problems peculiar to the cell using the laminate film sheet 22 for a case.

The laminate film sheet 22 here comprises the laminate film in which, for example, PET (polyethylene terephthalate), aluminum foil, adhesive layer, first modified polyolefin layer, and second modified polyolefin layer are stacked and then joined into an integrated form, and the polyolefin layer inside the laminate film sheet can be welded each other by heating, so that the cell is able to be sealed.

When the laminate film sheet is used for a cell case, therefore, application of thermoplastic resin to a part of the surface of a lead or a terminal makes it possible for the thermoplastic resin and the polyolefin layer inside the laminate film sheet to be adhered by heating. In this manner, a cell can be easily sealed. The laminate film sheet which contains an aluminum foil as one of the layers to be stacked in the laminate film sheet can be referred to as aluminum resin laminate sheet.

### BRIEF DESCRIPTION OF DRAWINGS

FIG. 1 is a perspective view showing an embodiment of the invention and showing the configuration of a wound type power generating element of a non-aqueous electrolyte secondary cell.

FIG. 2 is a perspective view showing an embodiment of the invention and showing a core on which a positive lead and a negative lead are fixed.

FIG. 3 is a perspective view showing an embodiment of the invention and showing another example of a core.

FIG. 4 is a cross-sectional view showing the configuration of a stacked type power generating element of a non-aqueous electrolyte secondary cell.

FIG. 5 is a perspective view showing a non-aqueous electrolyte secondary cell which has a case made of laminate film sheet.

FIG. 6 is a perspective view showing the prior art example and showing a positive lead and a negative lead which are fixed on a core and electrodes of a power generating element.

In these figures, reference numeral 1 denotes a power generating element, 2 is a positive lead, 3 is a negative lead, 11 is a core, 11a is a resin sheet, 12 is a positive electrode, 13 is a negative electrode, 14 is a separator, 15 and 16 are adhesive tapes, 18 is an aluminum foil, 20 is a copper foil, 22 is a laminate film sheet, and 24 is a cell (a single cell.)

### DETAILED DESCRIPTION

Hereinafter, embodiments of the invention will be described with reference to the accompanying drawings.

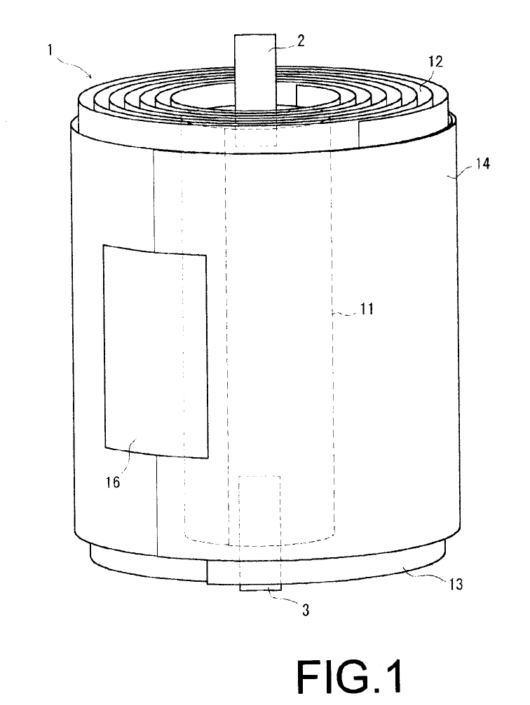

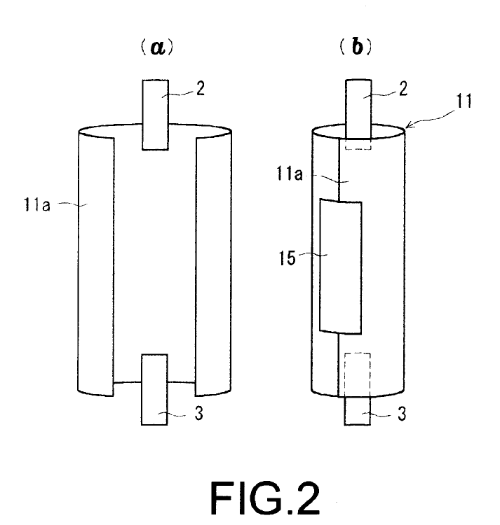

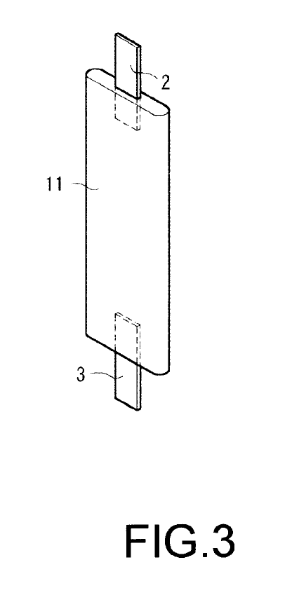

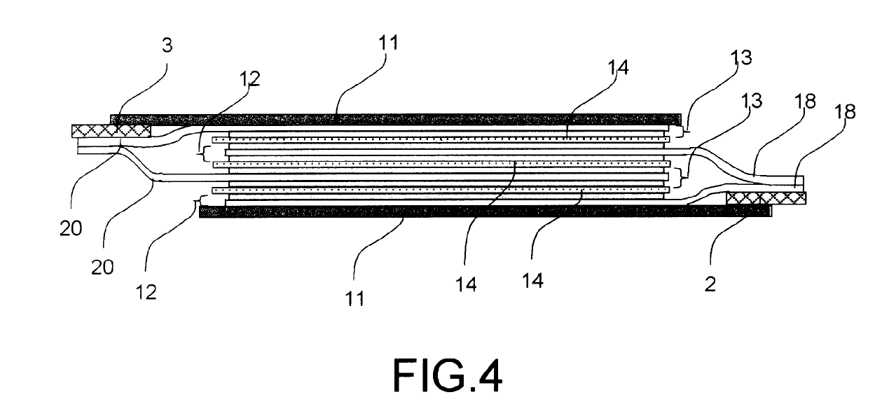

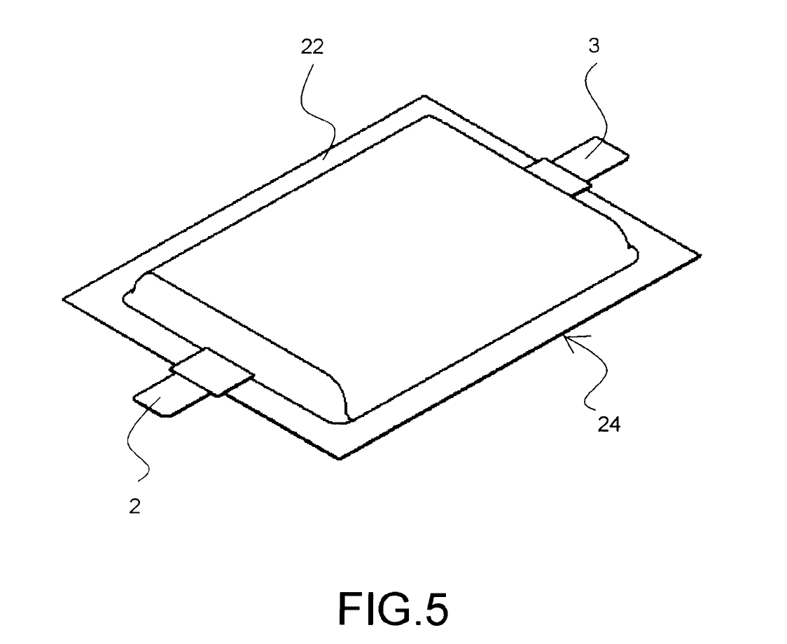

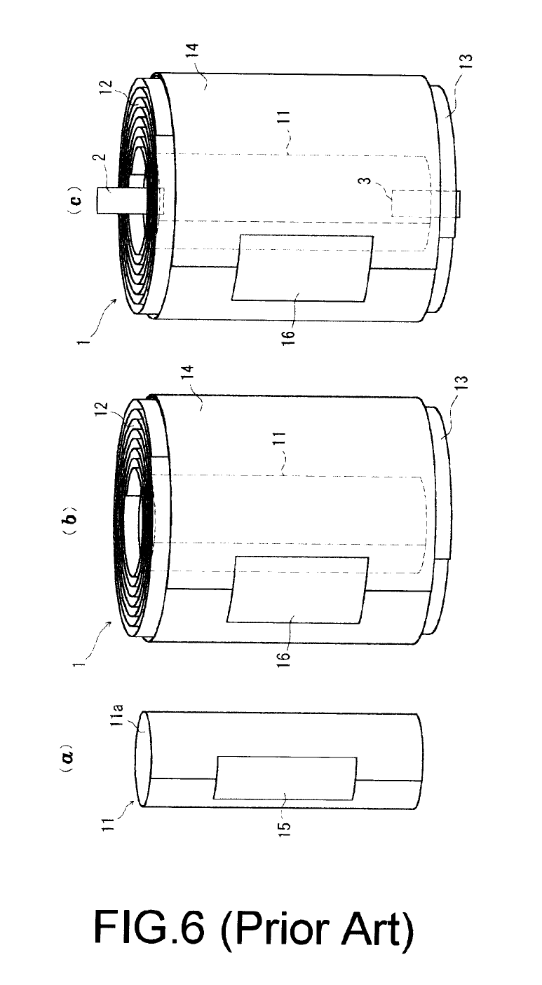

FIGS. 1 to 4 show an embodiment of the invention. FIG. 1 is a perspective view showing the configuration of a wound type power generating element of a non-aqueous electrolyte secondary cell. FIG. 2 is a perspective view showing a core on which a positive lead and a negative lead are fixed. FIG. 3 is a perspective view showing another example of a core. FIG. 4 is a cross-sectional view showing the configuration of a stacked type power generating element of a non-aqueous electrolyte secondary cell. FIG. 5 is a perspective view showing a non-aqueous electrolyte secondary cell which has a case made of laminate film sheet. The components in FIGS. 1 to 4 which have the same function as those of the prior art shown in FIG. 6 are denoted by the same reference numerals as in FIG. 6.

<First Embodiment>

The overview of the embodiment is the same as that of the prior art example. The embodiment relates to a non-aqueous electrolyte secondary cell in which an elliptic cylindrical power generating element of wound type is housed in an aluminum resin laminate sheet of a bag-like shape. The power generating element 1 of the non-aqueous electrolyte secondary cell is formed, as shown in FIG. 1, by winding the positive electrode 12 and the negative electrode 13 around the core 11 with the separator 14 therebetween.

The core 11 described above is formed, as shown in FIG. 2, by rolling a strip resin sheet 11a more than one round. The resin sheet 11a is an insulating sheet material, such as PET or PP, having such resin property that it can be rolled into and remain in an elliptic cylindrical shape as the core 11. In the resin sheet 11a, as shown in FIG. 2(a), one end of a positive lead 2 is previously fixed on one edge portion of the strip (the upper portion in FIG. 2), and one end of a negative lead 3 is previously fixed on the other edge portion of the strip (the lower portion in FIG. 2.). The positive lead 2 comprises a metal plate such as a strip of aluminum or aluminum base alloy, and the negative lead 3 comprises a metal plate such as a strip of copper or copper base alloy. Such positive and negative leads 2 and 3 are fixed on the edge portions of the resin sheet 11a, not shown in the figure, with a pressure-sensitive adhesive double coated tape or an adhesive agent, or by heat welding. The resin sheet 11a on which the positive and negative leads 2 and 3 are fixed in such a manner is rolled more than one round, as shown in FIG. 2(b), and the end portion of the roll is fastened with an adhesive tape 15, thereby configuring the core 11. Accordingly, one end of the positive lead 2 protrudes upward from the upper end of the core 11 and one end of the negative lead 3 protrudes downward from the lower end of the core 11.

In the embodiment, as shown in FIG. 1, the power generating element 1 of the non-aqueous electrolyte secondary cell is formed so that the positive electrode 12 and the negative electrode 13 of long strips are wound around the above described core 11 with the separator 11 therebetween. The configuration of the positive electrode 12, the negative electrode 13 and the separator 14 is the same as that of the prior art example shown in FIG. 6. In the same manner as the prior art example, the positive electrode 12 and the negative electrode 13 are wound with being slightly shifted from each other around the core 11 with the separator 14 therebetween, thereby causing only aluminum foil of the edge portion of the positive electrode 12 to protrude in one end of the power generating element 1, or, the upper end in FIG. 1, and causing only copper foil of the edge portion of the negative electrode 13 to protrude in the other end, or, the lower end in FIG. 1. The separator 14 which is also disposed in the same manner as the prior art example has an extra winding of more than one turn at the outermost periphery, and the end of the winding is fastened with an adhesive tape 16.

In the embodiment, the power generating element 1 is wound into an elliptic cylindrical shape in the manner as described above. That is, the core 11 of an elliptic cylindrical shape is inserted into a member the cross section of which is an ellipse, and the positive electrode 12 and the negative electrode 13 are wound around the core 11, thereby producing the power generating element 1 of an elliptic cylindrical shape. In another approach, the core 11 is inserted into a member the cross section of which is a circle, the positive electrode 12 and the negative electrode 13 are wound around the core 11, the member is drawn out after winding, and the side faces of the power generating element 1 are pressed from both sides, thereby producing the power generating element 1 of an elliptic cylindrical shape.

The positive lead 2 and the negative lead 3 are disposed so as to protrude upward and downward, respectively, from the center of the power generating element 1, which lies in approximately the middle of the straight line connecting the opposite bent ends of the elliptic cylinder.

A part of the positive lead 2 protruding upward from the core 11 is connected by ultra sonic wave welding to the aluminum foil portion of the positive electrode 12 protruding from the upper end of the power generating element 1. A part of the negative lead 3 protruding downward from the core 11 is connected by ultra sonic wave welding to the copper foil portion of the negative electrode 13 protruding from the lower end of the power generating element 1. In ultra sonic wave welding, the aluminum or copper foil portion lying on only one half side, with respect to from the center of winding to the outermost periphery, is lapped and then connected to one surface of the positive lead 2 or the negative lead 3, or the aluminum or copper foil portions lying on both sides, with respect to from the center of winding to the outermost periphery, are respectively lapped and then connected to both surfaces of the positive lead 2 or the negative lead 3 being disposed between them. In addition to ultra sonic wave welding, other approaches can be applied to connect the positive and negative leads 2 and 3 to the positive and negative electrodes 12 and 13, respectively, such as laser welding, caulking, screw fixation, or other adaptive means.

As described above, the power generating element 1 is housed in an aluminum resin laminate sheet of a bag-like shape, an electrolyte is then poured into the bag, and the bag is hermetically sealed with the positive lead 2 and the negative lead 3 being partly protruded, thereby producing a non-aqueous electrolyte secondary cell. To the positive and negative leads 2 and 3, the positive and negative electrode terminals, which are not shown, can be connected by welding, caulking, screw fixation and the like.

In the non-aqueous electrolyte secondary cell described above, the positive lead 2 and the negative lead 3 are not only connected to the corresponding non coated parts of the positive and negative electrodes 12 and 13 of the power generating element 1 but also fixed on the core 11. Therefore, when the non-aqueous electrolyte secondary cell suffers external impact or vibration in this embodiment, compared to the conventional example of having the possibility that only a power generating element is shifted because of the massive formation in the case made of an aluminum resin laminate sheet, both ends of the core 11 in the power generating element can be supported by the positive lead 2 and the negative lead 3, so that the movement of the power generating element 1 can be controlled inside the cell. In other words, in the event that the positive lead 2 and the negative lead 3 being disposed on both sides of the cell, respectively, are fixed and then tested by a vibration test machine, each of the leads receiving vibration from the test machine transmits the vibration all over the power generating element, which causes the whole body including the lead and the power generating element to vibrate integrally, and hence the lead is not detached from the corresponding electrode and the electrode lying in the connection part is not broken. Furthermore, even when the power generating element 1 moves inside the aluminum resin laminate sheet because of the significant impact or vibration being inflicted on the non-aqueous electrolyte secondary cell, the part of fixing on the core 11 moves together with the power generating element 1, so that the part of connection to the positive electrode 12 or the negative electrode 13, which lies in the close vicinity of the fixing part, is not likely to be detached from the aluminum foil or the copper foil. Therefore, even when the non-aqueous electrolyte secondary cell suffers impact or vibration, it is possible to prevent certain external force from being applied to the position where the positive or negative lead 2 or 3 is connected to the positive or negative electrode 12 or 13, and hence the aluminum foil or copper foil of the connection part is not broken.

In addition, the positive lead 2 and the negative lead 3 can be fixed in advance on the resin sheet 11a of the core 11, so that when connection to the positive or negative electrode 12 or 13 is carried out after winding process, the positive lead 2 and the negative lead 3 are prevented from being displaced, such as being inclined or getting out of the core 11, and as a result there is no fear that the connection is made at an incorrect position or insufficiently.

In the embodiment described above, the core 11 is formed by rolling the resin sheet 11a; however, a resin molding of an elliptic cylindrical shape can also be used as the core 11, as shown in FIG. 3. When the core 11 comprises such a resin molding is used, the positive lead 2 and the negative lead 3 can be fixed on the surface of the resin molding, and also, as shown in FIG. 3, a part of them can be implanted and fixed by means of insert molding. Therefore, the core 11 is not limited to resin if it is an insulation material having rigidity enough to be able to serve as a core, and also any configuration type can be applied such as a sheet wound type or moldings. Furthermore, as for the way to fix the positive lead 2 and the negative lead 3 on the core 11, any method can be used for fixing including the use of an adhesive tape, implant molding, and the like.

The positive lead 2 and the negative lead 3 may serve, in some cases, as separate parts from the positive terminal and the negative terminal, or in other cases serve as parts of the positive terminal and the negative terminal being joined together in a unified manner. Moreover, such positive lead 2 and the negative lead 3 may not directly be connected to the positive terminal and the negative terminal, respectively, but be connected to each of the corresponding terminals by means of inter-connecting member.

In the embodiment described above, the positive electrode 12 and the negative electrode 13 in the power generating element 1 are prepared so as to have the portions on which the active material is not coated, and then wound with being slightly shifted from each other with the separator 14 therebetween; however, the configuration of the power generating element 1 is not limited to this type. For example, being equipped with a tab-like connection part, the positive electrode 12 and the negative electrode 13 are wound in a manner that such connection parts protrude from the ends of the power generating element 1, and the respective connection parts are connected to the positive lead 2 and the negative lead 3; therefore, there is no need to wind the positive electrode 12 and the negative electrode 13 with being shifted each other in the direction of the winding axis. Furthermore, the material of the separator 14 can be selected optionally, and hence provided that the positive electrode 12 and the negative electrode 13 are made to separate completely with a electrolyte layer, there is no need to dispose the separator 14 between them.

In the embodiment described above, both of the positive lead 2 and the negative lead 3 are fixed on the core 11; however, the same effect can also be obtained by fixing either lead on the core 11. Especially in the event that current collection is made from the other electrode lying in the outermost periphery of the power generating element 1, since it is enough for current to be collected from one electrode in the end of the power generating element 1, what is needed is to fix on the core 11 only the lead to be connected to the one electrode.

Furthermore, in the embodiment described above, an elliptic cylindrical shape is used for the power generating element 1. In case of a wound type power generating element 1 using a core 11, any type of shape is adaptable, and hence the cross section may be not only in the shape of an ellipse but also in the shape of oval or others, and even a power generating element 1 of a common cylindrical shape is likewise applicable. In addition, a cell case housing the power generating element 1 is not limited to the aluminum resin laminate sheet of a bag-like shape; therefore it is possible to use a cell can made of metal, a cell container made of resin, or others. Moreover, as for the non-aqueous electrolyte secondary cell in the embodiment described above, the type of cell is not limited specifically. According to the type of cell, therefore, it is possible to determine the material or configuration of each element in the power generating element 1, the positive lead 2, and the negative lead 3.

<Second Embodiment>

The overview of the embodiment, with respect to the configuration, is shown in FIG. 4. The embodiment relates to a non-aqueous electrolyte secondary cell in which a power generating element of stacked type is housed in an aluminum resin laminate sheet of a bag-like shape. The power generating element of the non-aqueous electrolyte secondary cell is formed, as shown in FIG. 4, by stacking the positive electrode 12 and the negative electrode 13 on a core 11 with a separator 14 therebetween. The number of the electrodes to be stacked can be optionally selected according to the discharge capacity designed to be obtained from the nonaqueous electrolyte secondary cell. In the embodiment, two positive electrodes and two negative electrodes are employed.

As the material of the core 11, polypropylene is used and, as shown in FIG. 4, the core comprises two plates made of polypropylene. Between the two cores 11, the positive electrode 12 and the negative electrode 13 are stacked with a separator 14 between them, aluminum foils 18 serving as positive current collectors extend to one end of the power generating element, and copper foils 20 serving as negative current collectors extend to the other end of the power generating element.

Out of the two cores 11, on the top end (the lower right in the figure) of the core 11 lying in the lower side in FIG. 4, an aluminum-made positive lead 2 of a rectangular shape is disposed, and the area making contact with the core 11 is fixed. In the embodiment, a pressure-sensitive adhesive double coated tape, not shown in the figure, is used as a means of fixing; in addition to this, an adhesive tape or an adhesive agent is applicable. On the positive lead 2, said extending aluminum foils 18 are stacked together and connected on the top end of the positive lead 2 (the right end in the figure) by ultra sonic wave welding. In such a manner, the position of the fixing part is made different from the position of the connection part with respect to the extending direction of the lead.

On the other hand, on the top end (the upper left in the figure) of the core 11 lying in the upper side in FIG. 4, a copper-made negative lead 3 of a rectangular shape is disposed, and the area making contact with the core 11 is fixed. In the same manner as the positive lead 2, a pressure-sensitive adhesive double coated tape, not shown in the figure, is used as a means of fixing; in addition to this, an adhesive tape or an adhesive agent is applicable. On the negative lead 3, said extending copper foils 20 are stacked together and connected on the top end of the negative lead 3 (the left end in the figure) by ultra sonic wave welding. As a means of connection, other welding methods, rivet fixation, and the like can also be used.

According to these procedures, the positive lead 2 and the negative lead 3 which are fixed on the two cores, respectively, are disposed so as to protrude almost by-directionally with respect to the cell. Then the respective leads are to be electrically connected to the positive or negative current collector, respectively.

The power generating element with the cores thus formed is housed, with being pressed from both sides, in an aluminum resin laminate sheet which is so adjusted in size as to be able to house said power generating element. After the power generating element is housed, an electrolyte is poured, and then the aperture of the aluminum resin laminate sheet is sealed with a vacuum being drawn inside the aluminum resin laminate case; thereby producing a non-aqueous electrolyte secondary cell comprising a stacked type power generating element with the core 11. To the positive lead 2, the positive terminal, which is not shown, is connected, and to the negative lead 3, the negative terminal, which is not shown, is connected. As a means of connection, ultra sonic wave welding is used so as to allow the respective leads and the terminals to be connected electrically; in addition to this, other welding methods, rivet fixation, and the like can be used.

In the non-aqueous electrolyte secondary cell described above, the positive lead 2 and the negative lead 3 are not only connected to the corresponding non coated parts of the positive and negative electrodes 12 and 13 of the power generating element 1 but also fixed on the core 11. Therefore, when the non-aqueous electrolyte secondary cell suffers external impact or vibration in this embodiment, compared to the conventional example of having the possibility that only a power generating element moves because of the massive formation in the case made of aluminum resin laminate sheet, the positive lead 2 and the negative lead 3 vibrate together not only with the core 11 but also with the whole power generating element 1 with the core 11. This prevents the power generating element 1 from moving alone inside the case, and hence there is no fear that the positive lead 2 or the negative lead 3 are detached from the positive electrode 12 or the negative electrode 13 respectively in the position where the positive lead 2 or the negative lead 3 is connected to the positive electrode 12 or the negative electrode 13. Accordingly, in the event that the positive lead 2 and the negative lead 3 being disposed on both sides of the cell, respectively, are fixed and then tested by, for example, a vibration test machine, each of the leads receiving vibration from the test machine transmits the vibration all over the power generating element, which causes the whole body including the lead and the power generating element to vibrate integrally. As a result, the lead is not detached from the corresponding electrode and the electrode lying in the connection part is not broken.

In addition, the positive lead 2 and the negative lead 3 can be fixed in advance on the core 11, so that when connected to the positive electrode 12 or the negative electrode 13 after stacking process, the positive lead 2 and the negative lead 3 are prevented from being connected at a slant with respect to the cell or being connected insufficiently.

Furthermore, in the embodiment described above, an aluminum resin laminate sheet is used for the cell case housing the power generating element; however, in the present invention, in addition to the aluminum resin laminate sheet, it is possible to use a cell can made of metal, a cell container made of resin, or others. Moreover, as for the non-aqueous electrolyte secondary cell in the embodiment described above, the type of cell is not limited specifically. According to the type of cell, therefore, it is possible to determine the material or configuration of each element in the power generating element, the positive lead 2, and the negative lead 3.

This application is based on Japanese patent application No. 2002-341260 filed on Nov. 25, 2002, the entire contents thereof being hereby incorporated by reference.

1. A cell comprising:
a lead;
a power generating element which comprises a positive electrode, a negative electrode, and a separator; and
a core,
wherein said lead for taking current from said power generating element is fixed on said core, and said lead is connected to said positive electrode or said negative electrode.

2. The cell according to claim 1,
wherein said power generating element is a wound type power generating element which is formed by winding electrodes around said core.

3. The cell according to claim 1,
wherein said power generating element is a stacked type power generating element which is formed by stacking electrodes together with said core.

4. The cell according to any one of claims 1 to 3,
wherein the position where said lead is fixed to said core differs from the position where said lead is connected to said electrode with respect to the extending direction of said lead.

5. The cell according to any one of claims 1 to 3,
wherein the position where said lead is connected to said electrode is disposed at the outer side of said core end.

6. The cell according to any one of claims 1 to 3,
wherein said lead protrudes outside said cell.

7. The cell according to any one of claims 1 to 3,
wherein said lead is connected to a terminal having conductivity to the outer surface of said cell.

8. The cell according to any one of claims 1 to 3,
wherein the said core is insulative.

9. The cell according to any one of claims 1 to 3,
wherein a case of said cell which houses said power generating element comprises a laminate film sheet.

10. The cell according to claim 9,
wherein a thermoplastic resin is applied to a part of surface of said lead, so that said thermoplastic resin and said laminate film sheet adhere each other.

11. A method for making a power generating element comprising the steps of:
fixing a lead for taking current from a power generating element on a core, and
after said fixing process, connecting said lead to an electrode of said power generating element.
